(19) United States
(12) Patent Application Publication
(10) Pub. No.: US 2004/0152052 A1
(43) Pub. Date: Aug. 5, 2004

(54) Apparatus and method to prompt instinctive flight instrument scanning

(76) Inventor: John Edward Evans JR., Wilmington, NC (US)

Correspondence Address: Michael E. Mauney, Attorney at Law, Post Office Box 10266, Southport, NC, 28461, US

(21) Appl. No.: 10/358,846

(22) Filed: Feb. 5, 2003

(51) Int. Cl. G09B 9/02; G09B 19/16

(52) U.S. Cl. 434/29; 434/59; 434/238

(57) ABSTRACT

A device for prompting a scan pattern. In many circumstances it is important that an individual be able to follow a learned scan pattern in highly stressful situations. It is therefore important that an individual be taught a particular scan pattern in a way that is most likely to be remembered by a user in these stressful situations. A pilot flying by instruments must appropriately scan the instruments and control the aircraft in accordance with information obtained from the instruments. An improper scanning pattern can cause the pilot to lose control of the aircraft. Consequently, a device that utilizes multiple sensory inputs will more quickly and permanently impress a scanning pattern on a user. Here, a flight instrument scanning pattern is prompted by this device, which selectively illuminates each instrument in the desired scanning pattern to attract a user's attention to that particular instrument. Concurrent with the illumination of the particular flight instrument, a particular sound is emitted by the training device thereby utilizing the user's sense of sight and sense of hearing. Additionally, tactile stimulators can be provided so that a characteristic tactile sensation will be perceived by a user and connected with a particular instrument in the flight instrument, thereby the senses of sight, hearing, and touch are all involved in prompting a scan pattern and in learning a scan pattern. The training device can be programmed to change the timing both to reflect the learning curve of a user and to attune to the natural rhythms of a user.

### TECHNICAL FIELD

This invention is designed to utilize the inherent characteristics of a given student and known learning modes to prompt and/or teach instinctive scanning of a set of instruments. It will have its greatest application where the instrument scanning sometimes takes place in a highly stressful environment that can disrupt learned patterns or responses. It is believed this invention will have its greatest application in scanning of flight instruments for a pilot while flying, but would have application as well in other settings where a scanning pattern must be followed such as medical or security monitoring.

### BACKGROUND OF THE INVENTION

It has long been known that performance skills of an individual can degrade in highly stressful environments. This can be due to a large number of factors. Stress ordinarily produces a psychological response sometimes called the “flight or fight” response. In this response, a person's pulse rate increases, their blood pressure rises, blood flow to the periphery of the body is restricted, respiration rate rises, and reflective or cognitive thought capabilities are diminished. People who are successfully able to manage this flight or fight response are highly valued and both literature and history are replete with examples of people who were cool-headed in a crisis and who are admired or even revered for their cool head.

Recently research has revealed that there are two different responses to a highly stressful situation, which differ widely from each other; but are equally destructive to efficient functioning of an individual. One such response is panic. In panic, the imperative to act is so great that it overrides the rational mind and people seize upon and act upon the first thought they have, even though that thought may be totally inappropriate and lead to destructive action. Swimmers who try to swim against a rip tide, exhausting themselves, and drowning are the victims of panic. Other examples of panic are passengers who have tried to open the exit doors in airplanes while the airplane is still flying or infantrymen who fire their rifle blindly and continue to fire it long after it is empty. A panic response may be defined by the characteristic that there is too little rational thought. This is in contrast to a “choking” response. The term “choking” is usually used to describe an athlete, but it can apply equally well to people in other situations. What is characteristic of a choking response is that an individual's rational mind completely takes over, thus the learned right brain sub-vocal habit patterns are displaced by the left brain vocal thinking. An athlete who is choking loses his fluid instinctual motions, which are replaced by labored rational motions. The characteristic of a choking response is that a person does everything by carefully measured, labored rational thought. In effect, they become like a beginner who has not learned how to do a function so that it is reduced to an instinctual habit. Everything is done in a labored, extremely careful fashion. On the whole, choking is better than panic, if it doesn't become too extreme. In the most extreme forms of choking, a person freezes completely and may become fixated on a single item or function, when a multi-task function is required.

In recent years, there has been much research about the choking and panic responses. The purpose of this research is to facilitate methods of training so that the performance of people of average intellectual and emotional capacity will be maximized in a highly stressful situation. This training teaches people a particular pattern to follow in a stressful situation, be it for an athlete, pilot, E.R.Nurse, or person training to respond in a crisis. Utilizing proper training that is designed to adjust for individual variations may maximize the performance in a stressful situation.

One area where a learned response can be applied in a highly stressful situation is in aircraft instrument scanning. Aircraft must be flown in a variety of weather conditions. At night or in bad weather conditions, it is necessary to fly by “instruments.” This means an airplane can be flown safely and landed even when normal visual references are obscured. This can be a problem, because sometimes following instruments can be counter-intuitive; that is, a pilot's inner ear and “seat” will tell him that his plane is flying straight when, in fact, it is turning, climbing or descending. In a hypothetical case, a pilot slowly enters a turn and does not notice it. As the turn becomes steeper, some of the lift generated by the wings is used to turn the aircraft as it banks, leaving less lift to hold the aircraft in level flight. The pilot does not notice the turn but does notice the loss of altitude because the turn is not “felt” as an increase of “g” force. The pilot pulls back the yoke, which has the effect of increasing drag and also has the effect of tightening the turn. If the pilot is fixated on the altimeter and does not level the wings, any further pulling back on the control yoke will only tighten the spiral and increase the rate of descent. This sequence of events results in what is called a “graveyard spiral.” This “graveyard spiral” is probably the cause of the accident that killed John F. Kennedy, Jr. The best protection against it is an effective instrument scan.

Basic types of flight instruments are found on virtually all aircraft and typically they are arranged in a stereotypical manner in two rows of three. In this stereotypical arrangement, the top central instrument is an artificial horizon. This instrument gives a pilot information that tells him how the aircraft is flying relative to an artificial horizon that appears on the instrument. Immediately below the artificial horizon instrument is a heading indicator, which tells the pilot what direction the aircraft is heading. To the right of the artificial horizon is an altimeter, which tells the pilot whether a plane is climbing, falling, or remaining at a steady altitude. To the left of the artificial horizon is an air speed indicator. This gives the relative speed of the airplane to the outside air. To the right of the directional or heading indicator is a vertical speed indicator. This indicates the rate of climbs or descents. To the left of the heading indicator is a turn and bank indicator. This instrument is below the air speed indicator. This tells the pilot whether the plane is level or whether it is banking and whether the nose and tail of the aircraft are aligned with the direction of travel.

While there may be variations among these instruments, all are found in an aircraft and, when used properly, give sufficient information to pilot the aircraft. When a pilot is learning to fly an aircraft by instruments, it is typical for a pilot to fixate on only one instrument. This fixation is indicative of a person who is “choking”. Consequently, it has long been understood that part of the pilot training is to teach a pilot to scan the instruments in a proper sequence and frequency. The Federal Aviation Administration in its instrument flying handbook (FAA-8-8083-15) indicates that instrument scanning or cross-checking must be learned. That suggests that a pilot maintain an attitude by references to instruments that will produce a desired result. Due to human error and airplane performance, it is impossible to establish an attitude and have it remain constant for a long period of time. Consequently, a pilot must necessarily check the instruments and make appropriate changes in aircraft attitude. The FFA Handbook suggests various patterns for doing this, including the selected radial scan, the inverted V scan, and a rectangular scan. The FFA handbook suggests that basic instrument proficiency must be maintained through practice and that errors are expected. It points out that fixation or staring at a single instrument is a common error. It is also common to omit an instrument from the cross check or that there can be over emphasis on a single instrument. Because of the critical need for appropriate instrument scanning, cross-checking, and skills, and because of the difficulty of this procedure, a variety of devices have been proposed to teach a pilot about instrument flight and about instrument scanning.

For example, Reynolds, U.S. Pat. No. 3,546,350, proposes a training device connected to a simulator navigation radio panel, which can be used by a flight instructor during a normal flight. The student is hooded so that he can only see the instrument panel with the Reynolds invention. The instructor, on the other hand, has full view of the landscape. The instructor manipulates an artificial set of navigation instruments, so that a student is required to guide the aircraft according to these instrument indications. This allows the student to practice instrument approach high in the air and away from the airport for greater safety. Greenburg et al., U.S. Pat. No. 3,992,786, proposes an apparatus that has an artificial instrument panel in a portable device. The apparatus is programmed so that the instruments undergo a particular procedural sequence and the student's response to that sequence is tested, errors are recognized, and are reported. Seay et al., U.S. Pat. No. 4,470,819, proposed a flat (cardboard) simulated instrument panel. Visual indicators selectively provide simulated flight instruments. Adjustments on the flight instruments can teach the student to interpret various instruments, depending on the maneuvers for which teaching is being provided. Hardesty, U.S. Pat. No. 5,222,893, proposes an assemblage of instruments in a simulated instrument panel. Ports open and close to expose an instrument in a programmed sequence. On and off back lighting can also be employed to periodically reveal or conceal instruments behind a translucent face. Instruments are alternately exposed in a programmed sequence, training a student to follow a particular sequence in scanning a particular set of instruments. Despite this earlier work, there is still no adequate system for training a student to scan light instruments in the stress of actual flying. The previous art is too cumbersome and unnatural while not addressing the core requirement of safe instrument flight through scan imprinting.

### SUMMARY OF THE INVENTION

This invention is designed to teach and imprint appropriate scanning practices. This invention uses a small pulse of light or other visual cue, sound, and tactile stimulation to attract the attention of the user to one or more information sources. Multiple sources of information will be illuminated in a predetermined sequence. The light or other visual cue will be adjustable with regard to intensity, color, duration, interval and sequence. Sound reinforces the rhythmic effect of the flashing lights by following the light rhythm. Tactile stimulation mirrors the visual cue position as it sequences by stimulating different parts of the pilot's body opposite the visually cued instruments. Multiple scan patterns are offered as recommended by the FAA in their instrument training manual. This invention uses the principle of stimulating more than one sense in order to intensify the learning process. A portfolio of several sounds will be available including a computer-generated tone followed by an octave interval, and a heartbeat followed by a click. A binaural effect may be used to add additional positioning information cues. This would allow for the creation of the illusion that the sound is coming from the exact place where the visual information is available. A rhythmic overlay may also be superimposed over a popular tune as a self-prompting memory device. The overall intent is to use a sound that is comfortably internalized by the student and creates the effect of restful alertness.

This invention is not a simulator. It can supplement either an existing simulator or an actual aircraft. The sequencing of the rhythmic sound, visual cue, and tactile stimulus is controlled by the instructor using a box with a computer and controls for input. In a removable installation, the lights may be attached to instrument faces by suction cups or other mechanical means. Connecting wires may be Velcro-attached to the panel. When a reference is made to “illuminating” an instrument, it should be understood that “heads up” displays and screen displayed data would have appropriate but possible, different visual cues. If the application is to a “heads up display” or “glass cockpit” screen display, the visual cue could take the form of data representation made bolder or otherwise made to stand out visually. A permanent installation might build in back-lighting devices. The sounds are introduced to the pilot's headphones and will be suspended by an Audio Ducker circuit when radio transmissions are sent or received. The tactile stimulation could be provided in the back of the pilot's seat in a pattern that mirrors the instrument layout. The signal generator is battery-powered. It can also be powered by plugging into the cigarette lighter. When used in an actual aircraft, the device can be used for training or in actual instrument flight to augment and reinforce the necessary scan patterns required for safe instrument flying.

With practice, the student will show mastery in scanning and interpreting the instruments while making control inputs to maneuver the aircraft. As this happens, the rate of scan will be increased by the instructor to allow for greater precision in maneuvers. Numerous small control inputs by the pilot are preferable to a few gross control inputs for reasons of precision and smoothness. Near the completion of training, the intensity of sound, visual cue, and tactile stimulation can progressively be reduced until it is no longer consciously perceivable so that the student does not become dependent upon it. The device can be used in actual instrument flight to emphasize to a pilot the need to follow the scanning pattern required for safe flight, either in special circumstances or routinely if desirable.

The methods chosen to stimulate attention for scan development are carefully chosen to access deep, primitive and instinctive attributes of the human psyche. For example, the detection of subtle movement and interpretation is the most basic skill necessary in locating game animals. A deer does not usually walk into clear view in front of a hunter. Rather, a flick of the ear or broken twig attracts the attention to the correct quadrant. A careful and informed interpretation only then detects the quarry's form behind a screen of brush, limbs and leaves. Tactile stimulation reinforces the visual cue and sound stimulation and helps to overcome any dyslexic tendency. Sound, especially rhythmic sound, also draws upon a deep and instinctive human response. The various mechanisms of the human life are constantly seeking and maintaining a proper rhythmic interrelationship. Drums and rhythmic activity have always been associated with humans. The heartbeat, usually beating about once a second, is constantly sensed, albeit subconsciously. It so happens that scanning instruments at the rate of once a second is a good interval for many applications. The reason for drawing upon deep and instinctive responses is that a flying machine is the ultimate artificial environment. Constant mechanical noise, counter-intuitive behavior, disembodied (radio) voices, erratic movement from wind currents and a garden of moving gauges, create a powerful tendency toward confusion, catatonia or panic. The usual prescription for overcoming these dangerous evils is to look outside the aircraft and gaze at the horizon. This is exactly the opportunity that is unavailable to a pilot flying in the clouds.

Another consideration is the orientation of the awareness of the student. The necessary elements of awareness, intelligence and knowledge reside as subjective qualities. Information and action are objective. The key to successful function is the artful joining of the objective and subjective. Sound, if well chosen, can resonate deep within our being and marshal inner resources. Focused visual cues attract focused attention. As used in this system, it is objective. Touch is perhaps the most intimate and personal of our senses. The use of tactile stimulation reinforces the visual cue and sound stimuli. The object of this invention is to bring inner and outer orientation into a rhythmic and comfortable interrelationship while gently leading the process of awareness to a sequential and useful scan.

Successful instrument flying requires that an instrument pilot develop a deep and unshakable knowledge of procedure and a habitual scan. Experience has shown that effective scan development is the essential precondition upon which all other instrument flying skills are balanced. Scan development is not only difficult to develop, it is also subject to deterioration from disuse. This invention affirmatively leads the student to a firmer and systematic scan which will reduce training times and increase flight safety.

### BRIEF DESCRIPTION OF THE DRAWINGS

FIG. 1 is a block diagram showing elements of the current invention.

FIG. 2 is a flow chart of one portion of the operation of the current invention.

FIGS. 3A and 3B show the scan training device components in one embodiment.

FIG. 4 shows a placement of tactile pulse transducers for tactile stimulation.

### DETAILED DESCRIPTION OF THE DRAWINGS

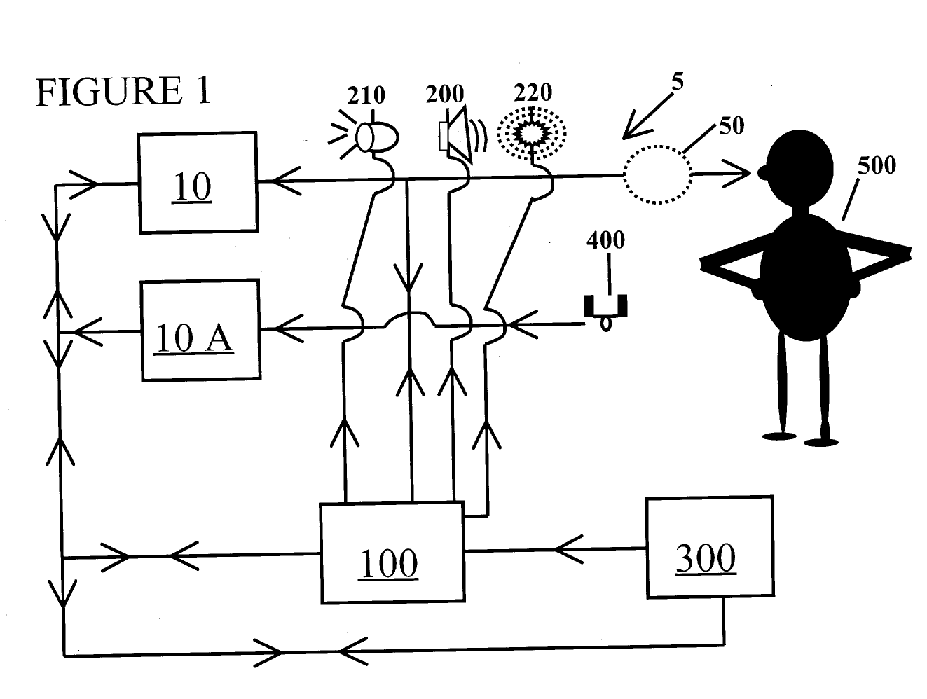

FIG. 1 displays in a highly simplified block diagram elements of the scan training device (5). First is a controller input unit (100) connected to at least one illumination source (210) that can selectively illuminate a training display (10), is connected to at least one sound output (200), and at least one tactile stimulator (220). The controller input (100) has means for receiving input from a controller (300). Typically, the training display (10) will consist of some visual display like an array of instruments. The training display (10) is perceived by a student (500) whose perception is modulated by the illumination source (210), sound output (200), and tactile stimulator (220) in the field of perception (50). The student input (400) is used by the student (500) to respond to what is displayed on the training display (10). For example, if a student (500) is in an airplane equipped with the current invention, the training display (10) will consist of a cluster of instruments and the student input (400) will consist of the aircraft controls. As shown in FIG. 1, the student input (400) is a control stick like aircraft controls, which could be the throttle control stick, and so on to control the flight of an aircraft (10A). For a car, the student input (400) would be the steering wheel, the brakes, and the accelerator. If the aircraft (10A) is a trainer aircraft with dual instrument displays and dual aircraft controls, the controller (300) may be an instructor pilot in the aircraft with the student (500). The controller (300), here an instructor, will use the controller input (100) to illuminate one of the instruments on the training display (10) using the illumination source (210) and activate a corresponding tactile stimulator (220). The illumination of one of the instruments on the training display (10) and the corresponding tactile stimulator (220) affects how a student (500) perceives the instrument on the training display (10). Consequently, the effect of the illumination of one of the instruments, a sound from the sound output (200), and tactile stimulation is shown as a field of perception (50) in dotted lines. In other words, illuminating one of the instruments, making a sound, and corresponding tactile stimulation would not matter if a student (500) is not looking at the instrument. It is important that the sensory inputs from the illumination source (210), the sound output (200), and the tactile stimulator (220) actually affect the perception of the student (500). To better illustrate the importance of the perception of the student (500), the term “field of perception” (50), is used but this is not an actual device in the invention but a recognition of the flexible, lens-like nature of human awareness. Hence, in FIG. 1 the field of perception (50) is shown in dotted lines. It is so shown to be sure there is no confusion that the psychological construct represented in FIG. 1 as the “field of perception” (50), is not an actual physical device. So it is important that there not simply be a passive training display, but there be an interactive way for the controller (300), effected by the controller input (100), to have an input into the psychological construct termed the field of perception (50) of the student; hence, the use of the field of perception (50) in FIG. 1. In the same manner, the controller (300) will use the controller input unit (100) to cause the sound output (200) to sound a tone audible to the student (500), again affecting the field of perception (50) of the student (500). Here, that may be a connection through the sound system of the aircraft (10A) so that the headphones typically worn by a pilot (in this case, the student (500)), will produce a tone audible to the student (500). The controller (300), (here the instructor), will use the controller input unit (100) to cause illumination source (210) to illuminate an instrument (for example, the altimeter), and a transducer will stimulate the upper right-hand portion of the student's back (220), while simultaneously creating a sound using the sound output (200) to alter the field of perception input (50) for the student (500). In this fashion, the controller (300) will create a scanning pattern for training using illumination source (210) to illuminate an object, here an instrument, coupled with the sound output (200) and tactile stimulator (220) to create an influence in the field of perception (50) to teach a scanning pattern to a student (500). In this way, the sound output (200), the illumination source (210), and the tactile stimulator (220) interpose and modulate the attention (field of perception (50)) of the student (500) as he gathers input from the training display (10). The student (500) interprets the information gathered from the training display (10) and responds using the student input (400). The student input (400) will cause changes in the device controlled by the student, here an aircraft (10A). Changes in the aircraft (10A) performance are reflected on the training display (10) or instrument panel. The student (500) then scans the training display (10) but the scan is modulated through the field of perception (50) by the illumination source (210), the sound output (200), and the tactile stimulator (220). The controller (300) uses the illumination source (210), the sound output (200), and the tactile stimulator (220) to modulate and control a rhythmic scan pattern facilitating a feedback loop between the training display (10), student (500), student input controls (400), and the aircraft (10A).

For example, in an aircraft with conventional gauges and using a radial cross check scanning pattern while in level flight, the following sequences of events would occur:

A light source would illuminate the attitude indicator, a sound generator would produce a tone in the headphones of the pilot and a transducer would stimulate the top center of the pilot's back.

A light source would illuminate the altimeter, a sound generator would produce a tone in the headsets of the pilot, and a transducer would stimulate the top right hand side of the pilot's back.

A light source would illuminate the attitude indicator, a sound generator would produce a tone in the headset of the pilot, and a transducer would stimulate the top center of the pilot's back.

A light source would illuminate the vertical speed indicator, a sound generator would produce a tone in the headset of the pilot, and a transducer would stimulate the bottom right side of the pilot's back.

A light source would illuminate the attitude indicator, a sound generator would produce a tone in the headset of the pilot, and a transducer would stimulate the top center of the pilot's back.

A light source would illuminate the heading indicator, a sound generator would produce a tone in the headset of the pilot, and a transducer would stimulate the bottom center of the pilot's back.

A light source would illuminate the attitude indicator, a sound generator would produce a tone in the headset of the pilot, and a transducer would stimulate the top center of the pilot's back.

A light source would illuminate the turn coordinator, a sound generator would produce a tone in the headset of the pilot, and a transducer would stimulate the lower left of the pilot's back.

A light source would illuminate the attitude indicator, a sound generator would produce a tone in the headset of the pilot, and a transducer would stimulate the top center of the pilot's back.

A light source would illuminate the airspeed indicator, a sound generator would produce a tone in the headset of the pilot, and a transducer would stimulate the top left of the pilot's back.

The pattern would then repeat for as long as necessary; attitude indicator, altimeter, attitude indicator, vertical speed indicator, attitude indicator, heading indicator, attitude indicator, turn coordinator, attitude indicator, airspeed indicator, attitude indicator, altimeter, etc.

The scan training device (5) allows for direct interaction between the controller (300) and the student (500). The controller (300) could use the controller unit (100) to break the ordinary scanning pattern to draw the student's (500) attention to a particular instrument if the student (500) had failed to scan the instrument or had taken some other action through the student input device (400), alerting the controller (300) that the student (500) was not properly following the training sequence or was not responding to information displayed on the training display (10) appropriately. The controller (300) could then monitor the student input (500) to determine if the student (500) was properly responding to the field of perception (50) going to the student (500). In this context, it is worth noting that the controller (300) need not be a live person but could be a central processing unit with an appropriate program loaded therein. It is also worth noting in this context, that the controller (300) and the student (500) need not be located in proximity to each other. The student (500) could be sitting at home working on his own computer where the training display (10) was on the computer display on the student's (500) computer at home. The controller input unit (100) and the controller (300) could be connected by a network to the student's (500) home computer and could, therefore, control the training display (10), the sound output (200), the illumination source (210), and the tactile stimulator (220) while receiving input from the student (500) through the network connection as the student (500) made appropriate responses using a computer mouse, joy stick, or such similar student input devices (400). As shown in FIG. 1, the item number “10A” is an aircraft, but it could be another type of vehicle like a car or could be any item for which a scanning pattern is an important part of controlling how the item number “10A” is controlled.

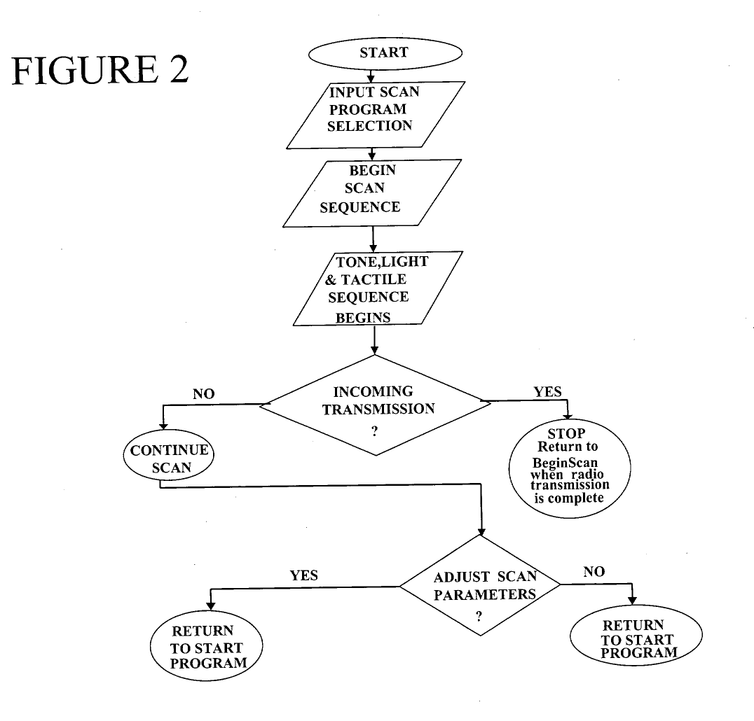

FIG. 2 is a flow chart that shows the sequence of operation for the scan training device (5) to teach proper instrument scanning techniques. The flow chart in FIG. 2 is labeled so that it is largely self-explanatory. It will be understood by one of skill in the art that the controller (300) (shown in FIG. 1) can either be a central processing unit alone or a central processing unit combined with a live instructor, or even a live instructor using manual controls only. If it is a live instructor using manual controls only, there will not be an actual computer program teaching scanning as part of the scan training device (5), but rather the instructor's skill and experience will substitute for a computer program. Nevertheless, the effects are the same in that a repetitive scanning pattern is taught using a combination of sight, sound and tactile stimuli to teach a student to follow a particulate scanning pattern and to respond appropriately to what is scanned during the pattern. In a microprocessor-controlled program, ordinarily one will start by choosing a scan program. The scan program could be a very simple one instrument or two instrument scan to a quite complex pattern of scanning which encompass a number of instruments scanned at different times and at different rates. In a microprocessor-controlled program, there will ordinarily be some sort of time limit or a counter to control the number of iterations that a particular student goes through in the process. This could be student controlled where a student could simply stop at a convenient stopping point. However, it is believed that there is a time frame for teaching a scanning program where a student will be most receptive to learning and that stopping the scanning program during this time will optimally train the student, while continuing the training program outside the time frame will be a waste of time or perhaps even counterproductive. A student may effectively be taught for a period of time, usually more than ten minutes but less than two hours for most students, but running the program for less than the minimum time will fail to give full benefit to the student, while going beyond the maximum time will produce little further results and may even be counterproductive. In FIG. 2, the flow chart is running continuously, but it will be understood that either a student or an instructor would manually stop the program at an appropriate time.

The flow chart shown in FIG. 2 begins in the box labeled “start”. The first step is to input the correct scan program selection. As was explained above, the scan program selection can range from simple to complex. Once the scan program is selected, the scan sequence will begin. This means that the controller (300) (not shown) will use the controller input unit (100) to illuminate one or more of the instruments on the training display (10) using an illumination source (210) while also using a sound stimulus through the sound output (200), and tactile stimulator (220) through a transducer or other source of tactile stimulation. This starts the timed sequence of light, sound and touch. The particular flow chart shown in FIG. 2 is predicated for use in an actual flight by a flight student. Consequently, the training sequence should not interfere with the operation of the airplane for obvious reasons. The sound output (200) will be used to directly input sound into a pilot's earphones and could, therefore, interfere with the reception of important radio transmission signals from other aircraft, aircraft controllers, or from other individuals, than the aircraft using the microphone and radio transmission to send transmissions. Consequently, if the controller (300) senses an incoming transmission on the student's headphones, the controller (300) will stop the touch, tone, and light sequence, which is shown as the “yes” option in FIG. 2. When the transmission is over, the controller (300) returns to the beginning scan sequence. If there is no incoming transmission, the scan will continue.

The scan parameters can be adjusted as required in response to the student input (400). The adjust scan parameter box could represent a quite complicated sub-routine designed to adjust the scan parameters depending on the student input (400). For example, if a student has not responded appropriately to the scan program, the program might adjust the scan parameters to intensify this illumination of the instruments or to use a difference sound stimulus or to use the touch stimulus so the student could respond by giving appropriate input to the student input (400). In either event, the program returns to the start if necessary. Scan parameters on the input scan program selection have been changed and the cycle begins again until stopped by the controller (300) or by the student (500).

It will be understood by one of skill in the art that in a microprocessor-controlled device each of these points on the computer program may represent a complicated sub-routine. For example, as one begins to pass through repeating iterations of the program, the program could speed up or slow down so that the time intervals between stimuli and the amount of time that a particular stimulus lasts may change or the scanning pattern could change. By the same token to determine whether a student input is correct or not may involve subtle distinctions or judgements which could require quite sophisticated programming to make these decisions about the correctness of a particular action of the student. The corrective input could vary widely depending on how the central processor is programmed. It could range from the very simple act of repeating the initial stimulus on the particular instrument scanned for which a correct input was sought or could consist of repeated stimuli, for example, a very direct stimuli such as a recorded or chip-activated voice could tell the student that the aircraft was in a dive and that the nose of the plane must be pulled up to correct the dive.

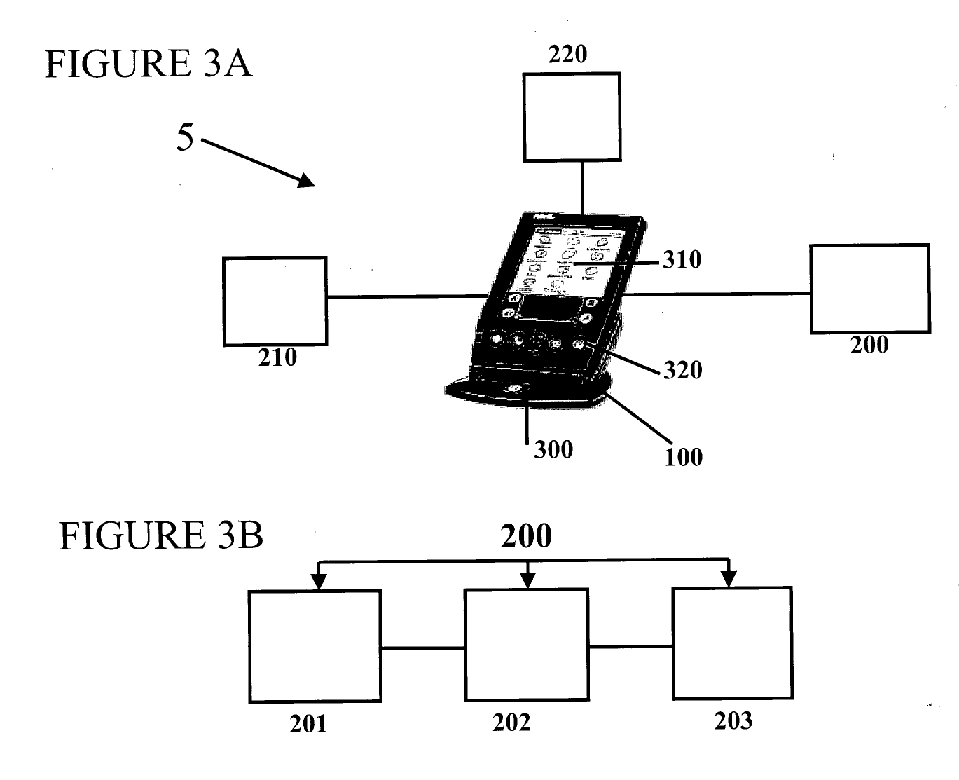

FIG. 3A shows the scan training device (5) in one type of embodiment that might be encountered in a commercial environment in a somewhat simplified form. The controller (300) and the controller input (100) are combined into a dedicated digital device not unlike a personal digital assistant or some such similar device. In the controller (300), when embodied in a small handheld microprocessor-cortrolled digital device, there would be a display screen (310). This ordinarily is a liquid crystal display or some other form of flat screen display, which is chosen both for its compactness and for its low power requirements. The display screen (310) could be used as an input device through touch screen programming in the controller (300). Here a keyboard (320) is shown, which can also be used for direct input into the controller (300). It will be appreciated by one of skill in the art that a desktop computer could be employed instead where the display screen (310) will be a CRT tube, the keyboard (320) will be a separate keyboard, and could include other means of inputting data or programs into the controller (300), such as a disk-reading device (floppy disk reader, DVD reader, compact disk reader), or the myriad of other kinds of devices that are used in desktop computers for inputting programming and data. Referring to FIG. 2, the keyboard (320) will be used to start the scan training device (5) to initiate a teach program. The display (310) could be used in conjunction with the keyboard (320) to allow a student to pick a particular scan teaching program from a variety of pre-loaded programs into the controller (300). The controller (300) will use the controller input (100) to control the illumination source (210), the sound output (200), and the tactile stimulator (220).

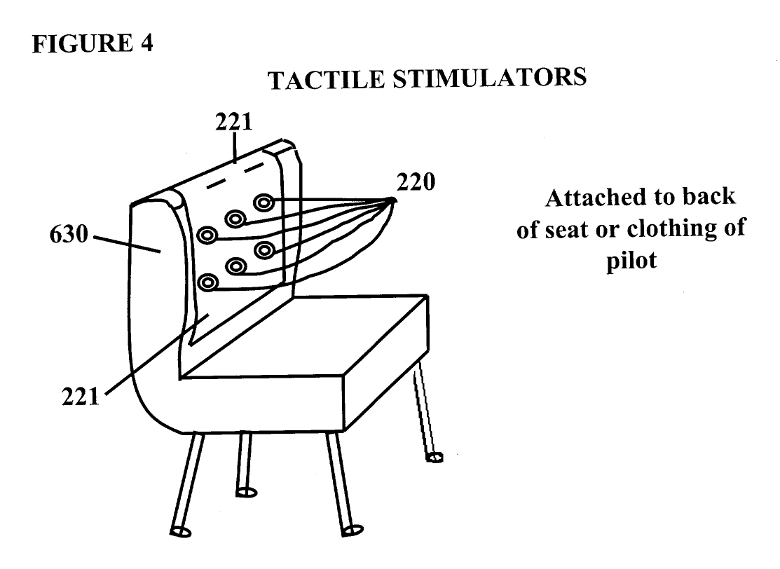

The illumination source (210) could be a variety of ways of illuminating a training display (10) (not shown). Ordinarily, this could be a light emitting diode of some kind. The light emitting diode could be attached to, or incorporated in, the instrument display in an existing aircraft and connected to the controller (300) and controller input (100) through wires or wireless means, or the illumination source (210) could be laser emitting diodes in a portable scan training device (5). This could be aimed at a particular instrument so that when the controller (300) wished to illuminate that particular instrument, the controller input (100) will activate a laser emitting diode so that a laser light will fall on that instrument or a light reactive material in proximity to that instrument to be perceived by a student (500) through the field of perception (50) as shown in FIG. 1. The precise nature of the illumination source and how it seeks to illuminate a particular instrument in a scanning pattern is largely a matter of choice depending on the particular application and the particular form of the scan training device (5) which is in use. The sound output (200) is shown in more detail in FIG. 3B. Here the sound output (200) is shown for an embodiment that will actually be used by a student pilot while in flight in an aircraft. The student pilot may be required to hear and respond to outside sounds, such as instructions from a control tower, radio calls from nearby aircraft, and so on. Therefore, it is important that the scan training device (5) be employed in such a fashion as to not interfere with these important, perhaps critical, signals from outside the aircraft wherein the student is employing the scan training device (5) to improve his scanning pattern. There will be a digital playback module (201) which can transmit a sound to a speaker or headphones (203) used by a student, but that the digital playback module (201) sound-generating signal passes through an audio interface (202), which mediates between the sound-generating signals of the digital playback module (201) and the outside sound signals such as radio transmissions from a control tower or nearby aircraft. This guarantees that a student (500) (not shown) will not be distracted from important information conveyed to him while using the scan training device (5) in an actual aircraft flight. Tactile stimulator (220) will be provided by transducers attached to the back of the seat or the pilot's garment which mirrors the configuration of the flight instruments. This reinforces the pattern shown by illumination of instruments. The tactile stimulator (220) is shown in more detail in FIG. 4. Headphones (203) are used as part of the sound output (200). It will be a relatively simple matter to provide a binaural or directional sense to the sound generated by the headphones (203) and heard by the student through the field of perception (50). This means that headphones (203) can make the sound apparently come from the particular place of the instrument on the training display (10). Of course, the directional nature of the sound would not be precise. It could be used in conjunction with the illumination source (210) and the tactile stimulator (220) to direct a student (500) to a particular instrument.

It will be appreciated by one of skill in the art that the controller (300) could be set up so that the keyboard (320) could be used for direct manual control where a live instructor used the scan training device (5) as opposed to using a pre-programmed scan training program within the controller (300). Under this circumstance, the controller (300) would serve as a controller input unit (100) with the keyboard (320) serving as a manual switch for an outside live training instructor who would be the actual controller (300).

FIG. 4 shows a plurality of tactile stimulators (220) employed on a removable piece (221) placed on a chair (630) that might be used by a student (500) (not shown). A plurality of tactile stimulators (220) are employed on a removable piece (221). Here, six tactile stimulators (220) are arranged in a generally rectangular pattern, mirroring the approximate pattern of flight instruments in an aircraft. Different numbers of tactile stimulators (220) could be employed or they could be arranged differently for different applications. The tactile stimulators (220) are activated by the controller (300) through the controller input (100) as appropriate to reinforce the particular scanning pattern being taught. It will be appreciated that the removable piece (221) could be configured as a garment to be worn by a student (500) or arranged in a variety of other ways to provide appropriate tactile stimulation for a student (500) during the implementation of a learning program by the scan training device (5).

By way of an example of a type of training program that could be used with a microprocessor-based controller (300) and controller input (100), as shown in FIG. 3A, a typical type of computer program is shown below. The first portion of the program lists variable names and their functions along with starting values for the program initiation or start-up. The next section of the program begins with the start-up module, which lead to a sub-routine selecting the instrument on the instrument panel that begins the scanning process. The program offers different types of scan parameters, including scan pattern type, duration of sound, light and tactile stimulation, interval between sound, light and tactile activation, intensity of sound, light and tactile stimulation, and quality of sound, light, and tactile stimulation. There is a description of a radial scan pattern, which is one of the known scan patterns as described in the Federal Aviation Administration Instrument Flying Handbook, pages 45. For example, in following this known scan pattern with this scan training device, there will be an audio tone, which may have characteristics unique to a particular instrument, then a light-emitting diode would flash to draw the student's attention to this instrument on the instrument panel while a vibration-emitting transducer mirrors the light-illuminated instrument on the instrument panel by a corresponding tactile pulse on the student's back. A scanning progression for a student might begin with the attitude indicator and continue to the next instrument in a particular scanning pattern on the panel. Each new instrument would be highlighted with an audio tone, a tactile stimulus, and a light from a light-emitting diode according to the scanning pattern chosen, which would ordinarily return to the attitude indicator, then go on to another instrument, then return to the attitude indicator, and so on. The training program continues using sound tones or even names of instruments along with a light-emitting diode flash on that particular instrument and a corresponding tactile pulse so that a student is prompted to follow the appropriate progression of the scan. When all instruments that should be scanned have been illuminated or highlighted with the accompanying tones and tactile pulses, then the program returns to the start module and restarts the scanning program from the beginning. The program is set up to halt operation of the sound portion of the scanning program and possibly, the tactile pulses, and light flashes if a radio transmission or communication is detected by a preprogrammed frequency test. At this point, the scan training program will stop with automatic shut-off of any audio input and, possibly, tactile pulses, and light flashes, and will not restart until the radio communication is complete. The following code is written in the P-Basic programming language for use in a programmable central processing unit usually in the form of a microprocessor.

| | | | |
|---|---|---|---|
| \acute{ }(STAMP BS2) | | | |
| \acute{ }VARIABLES | | | |
| DURATION | VAR | WORD | \acute{ }Variable for the Duration of the LED illumination |
| INTERVAL | VAR | WORD | \acute{ }Variable for the interval between LED illumination |
| TDURATION | VAR | WORD | \acute{ }Variable for the Duration of the Tactile stimulation |
| TINTERVAL | VAR | WORD | \acute{ }Variable for the interval between Tactile stimulation |
| PSWITCH | VAR | BYTE | \acute{ }State variable for the Program Switch |
| DSWITCH | VAR | BYTE | \acute{ }State variable for the Duration Switch |
| ISWITCH | VAR | BYTE | \acute{ }State variable for the Interval Switch |
| ACTIVE | VAR | BYTE | \acute{ }Variable to show active LED |
| TACTIVE | VAR | BYTE | \acute{ }Variable to show active tactile stimulation |
| QV_TONE | VAR | BYTE | \acute{ }Variable to select which tone is played by unit |
| VOLUME | VAR | BYTE | \acute{ }Variable to adjust volume on QV306 unit |
| T2400 | CON | 396 | \acute{ }Sets baud rate to 2400 for QV306 |
| QV_DIRECT | CON | $FO | \acute{ }Sets QV306 to direct addressing mode |
| QV_VOLUME | CON | $FC | \acute{ }Sets volume on QV306 |

\acute{ }STARTING VALUES
DURATION = 500
INTERVAL = 500
RDURATION = 500
TINTERVAL = 500

| | |
|---|---|
| QV_TONE = 1 | \acute{ }Variable to select which tone is played by unit |
| VOLUME = 45 MAX 64 | \acute{ }Variable to adjust volume on QV306 unit |

```
\acute{ }INITIALIZE QUADRAVOX QV306M1
LOW 8
PAUSE 100
HIGH 8
PAUSE 2000
SEROUT 9, T2400, [QV_DIRECT]
SEROUT 9, T2400, [QV_VOLUME]
SEROUT 9, T2400, [VOLUME]
\acute{ }INITIALIZE TACTILE STIMULATION
LOW 8
PAUSE 100
HIGH 8
PAUSE 2000
SEROUT 10, T2600
START:
IF DURATION >3000 THEN DDEFAULT
IF INTERVAL >3000 THEN IDEFAULT
IF TDURATION >3000 THEN DDEFAULT
IF TINTERVAL >3000 THEN IDEFAULT
GOSUB LED2
LED3:
HIGH 2
ACTIVE = 3
TACTIVE = 3
GOSUB BUZZ
LOW 2
PAUSE INTERVAL
PAUSE TINTERVAL
GOSUB LED2
LED6:
TINTADJUST:
LOW 15
PAUSE 250
HIGH 15
TINTERVAL = TINTERVAL +250
GOTOLOOP
DDEFAULT:
DURATION = 500
RETURN
IDEFAULT:
INTERVAL = 500
RETURN
VOLDOWN:
LOW 15
PAUSE 250
HIGH 15
VOLUME = VOLUME −1
SEROUT 9, T2400, [QV_VOLUME]
SEROUT 9, T2400, [VOLUME]
SEROUT 9, T2400, [QV_TONE]
\acute{ }DEBUG DEC VOLUME
GOTO VLOOP
VOLUP:
LOW 15
PAUSE 250
HIGH 15
VOLUME = VOLUME +1
SEROUT 9, T2400, [QV_VOLUME]
SEROUT 9, T2400, [VOLUME]
SEROUT 9, T2400, [QV_TONE]
\acute{ }DEBUG DEC VOLUME
GOTO VLOOP
HIGH 5
ACTIVE = 6
TACTIVE = 6
GOSUB BUZZ
LOW 5
PAUSE INTERVAL
PAUSE TINTERVAL
GOSUB LED2
LED5:
HIGH 4
ACTIVE = 5
TACTIVE = 5
GOSUB BUZZ
LOW 4
PAUSE INTERVAL
PAUSE TINTERVAL
GOSUB LED2
LED4:
HIGH 3
ACTIVE = 4
TACTIVE = 4
GOSUB BUZZ
LOW 3
PAUSE INTERVAL
PAUSE TINTERVAL
GOSUB LED2
LED1:
HIGH 0
ACTIVE = 1
TACTIVE = 1
GOSUB BUZZ
LOW 0
PAUSE INTERVAL
PAUSE TINTERVAL
GOTO START
\acute{ }SUBROUTINES
LED2:
HIGH 1
ACTIVE = 2
TACTIVE = 2
GOSUB BUZZ
LOW 1
PAUSE INTERVAL
PAUSE TINTERVAL
RETURN
BUZZ:
SEROUT 9, T2400, [QV_TONE]
BUTTON 12,1,255,255,PSWITCH,1,SETTINGS
BUTTON 13,1,255,255,DSWITCH,1,VSETTINGS
SEROUT 10, T2600
BUTTON 12,1,255,255,PSWITCH,1,TSETTINGS
PAUSE DURATION
PAUSE TDURATION
RETURN
SETTINGS:
LOW ACTIVE-1
HIGH 15
LOOP:
    BUTTON 12,1,255,255,PSWITCH,1,RESTART
    BUTTON 13,1,255,255,DSWITCH,1,DURADJUST
    BUTTON 14,1,255,255,ISWITCH,1,INTADJUST
    GOTO LOOP
TSETTINGS:
LOW ACTIVE-1
HIGH 15
LOOP:
    BUTTON 12,1,255,255,PSWITCH,1,RESTART
    BUTTON 13,1,255,255,DSWITCH,1,TDURADJUST
    BUTTON 14,1,255,255,ISWITCH,1,TINTADJUST
    GOTO LOOP
RESTART:
LOW 15
GOTO START
VSETTINGS:
LOW ACTIVE-1
HIGH 15
LOOP:
    BUTTON 12,1,255,255,PSWITCH,1,VOLDOWN
    BUTTON 13,1,255,255,DSWITCH,1,RESTART
    BUTTON 14,1,255,255,ISWITCH,1,VOLUP
    GOTO VLOOP
DURADJUST:
LOW 15
PAUSE 250
HIGH 15
DURATION = DURATION + 250
GOTO LOOP
TDURADJUST:
LOW 15
PAUSE 250
HIGH 15
TDURATION = TDURATION + 250
GOTO LOOP
INTADJUST:
LOW 15
PAUSE 250
HIGH 15
INTERVAL = INTERVAL + 250
GOTO LOOP
```

It will be appreciated that the foregoing description of a preferred embodiment is by way of example and not by way of limitation. The mechanical construction of the device may be varied without departing from the spirit of the invention. The only limitations are the claims which follow.

I claim:

1. An instrument for prompting a scan pattern comprising:
(a) a controller input unit;
(b) a plurality of sensory inputs controlled by said controller input unit;
(c) a plurality of objects, said plurality of objects to be scanned by a user;
whereby said controller input unit causes at least one sensory input in said plurality of sensory inputs to selectively direct a user's attention to at least one object in said plurality of objects.

2. An instrument for prompting a scan pattern of claim 1 wherein said plurality of sensory inputs includes at least one light source.

3. An instrument for prompting a scan pattern of claim 2 wherein said controller input unit further includes a definite planned program whereby said plurality of sensory inputs are controlled by said controller input unit to selectively direct a user's attention following said definite planned program prompting a user's attention to said plurality of sensory objects according to a particular scan pattern.

4. An instrument for prompting a scan pattern of claim 3 wherein said definite planned program further includes a means for controlling timing whereby said controller input unit may use said means for timing to selectively direct a user's attention at a rate to utilize a student's innate learning capacities.

5. An instrument for prompting a scan pattern of claim 4 wherein said plurality of sensory inputs includes at least one tactile source.

6. An instrument for prompting a scan pattern of claim 5 further comprising a programmable central processing unit connected to said controller input unit, said programmable central processing unit is programmed according to said definite planned program.

7. An instrument for prompting a scan pattern of claim 6 wherein said plurality of objects is a flight instrument panel for an aircraft.

8. An instrument for prompting a scan pattern of claim 7 wherein for each flight instrument in said flight instrument panel is provided with at least one light source controlled by said controller input unit.

9. An instrument for prompting a scan pattern of claim 8 wherein said plurality of sensory inputs further include at least one sound source.

10. An instrument for prompting a scan pattern of claim 9 wherein said at least one tactile source is arranged to correspond to at least one location of said instruments in said flight instrument panel.

11. An instrument for prompting a scan pattern of claim 10 wherein said at least one sound source is located in earphones used by a user of an aircraft.

12. An instrument for prompting a scan pattern of claim 11 wherein said programmable central processing unit is programmed to only deliver said sensory input from said plurality of sensory inputs when there is no conflict with an incoming transmission on said earphones.

13. An instrument for prompting a scan pattern of claim 12 wherein said definite planned program is controlled by said means for timing to be rhythmically attuned to a user's natural rhythm.

14. An instrument for prompting a flight instrument scan pattern comprising:
(a) a controller input unit;
(b) means for selectively illuminating flight instruments, said means for illuminating controlled by said controller input unit;
(c) a sound source perceptible by a user, said sound source controlled by said controller input unit;
(d) a plurality of tactile sources, said tactile sources perceptible by a user and controlled by said controller input unit;
whereby said controller input unit uses said means for illuminating, said sound source, and said plurality of tactile sources to uniquely direct a user's attention to a particular flight instrument in said flight instruments.

15. An instrument for prompting a flight instrument scan pattern of claim 14 wherein said controller input unit further includes a definite planned program whereby the user's attention is directed to a particular flight instrument in said flight instruments according to a definite scan pattern.

16. An instrument for prompting a flight instrument scan pattern of claim 15 wherein said definite planned program further includes means for controlling timing whereby a rate of scan in said definite scan pattern is controlled by said means for controlling timing.

17. An instrument for prompting a flight instrument scan pattern of claim 16 further comprising a programming central processing unit connected to said controller input unit, said programmable central processing unit programmed according to said definite planned program whereby said programmable central processing unit controls said controller input unit to prompt a flight instrument scan pattern without requiring an instructor.

18. An instrument for prompting a flight instrument scan pattern of claim 17 wherein said tactile sources are arranged to correspond to locations for each instrument in said flight instrument panel whereby a user can learn to associate the location of said tactile source with the location of said flight instrument in said flight instrument panel.

19. An instrument for prompting a flight instrument scan pattern of claim 18 wherein said programmable central processing unit is programmed only to deliver a sensory input from said means for illuminating, said sound source, and said plurality of tactile sources when there is no conflict with an incoming transmission.

20. An instrument for prompting a flight instrument scan pattern of claim 19 wherein said means for controlling timing is set at a particular rhythm whereby said particular rhythm may be attuned to the need of a particular user.

21. An instrument for prompting a flight instrument scan pattern of claim 20 wherein said sound source uses binaural methods to give an apparent location to sound generated by said sound source whereby a user's attention is directed to a particular flight instrument in said instrument panel by said apparent location of said sound source.

22. A method for prompting a user to scan a plurality of objects in a definite pattern including steps of:
(a) providing a controller input unit;
(b) using said controller input unit to control a plurality of sensory inputs;
(c) using said sensory inputs to direct a user's attention to said plurality of objects
whereby a user associates a sensory input with an object in said plurality of objects in a definite pattern controlled by said controller input unit.

23. A method for prompting a user to scan a plurality of objects in a definite pattern of claim 22 wherein said step of providing a plurality of sensory inputs includes providing at least one light source.

24. A method for prompting a user to scan a plurality of objects in a definite pattern of claim 23 in which said step of providing a controller input unit further includes providing a means for controlling timing whereby said controller input unit may use said means for timing to control the rate of scan of said plurality of objects.

25. A method for prompting a user to scan a plurality of objects in a definite pattern of claim 24 wherein said step of providing a plurality of sensory inputs includes a step of providing at least one tactile input.

26. An instrument for prompting a scan pattern comprising:
(a) a controller input unit;
(b) at least one sensory input;
(c) a plurality of objects, said plurality of objects to be scanned by a user;
whereby said controller input unit causes said at least one sensory input to selectively direct a user's attention to at least one object in said plurality of objects.

27. An instrument for prompting a scan pattern of claim 26 wherein said at least one sensory input is a sound source.

28. An instrument for prompting a scan pattern of claim 27 wherein said controller input unit contains means for controlling said at least one sound source so that said sound source attuned to a user's natural rhythm selectively directs a user's attention to at least one object in said plurality of objects.
